(19) United States
(12) Patent Application Publication
(10) Pub. No.: US 2009/0310357 A1
(43) Pub. Date: Dec. 17, 2009

(54) Collimation structure of led module and lamp using said led module

(76) Inventor: Kuo-Chin Huang, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,253

(22) Filed: May 5, 2009

(30) Foreign Application Priority Data
Jun. 13, 2008 (TW) 097210562

(51) Int. Cl. F21V 1/00; F21V 5/00; F21V 7/00

(52) U.S. Cl. 362/240; 362/311.02; 362/296.01

(57) ABSTRACT

This invention relates to a collimation structure of LED module and a lamp using said LED module. The collimation structure of the present invention mainly has a lens provided at a place along the irradiation direction of the light beam emitted from LED. The lens has a first curved surface and a second curved surface, and the curvatures of both are different from each other. In this manner, the object of collimating the light emitted from the LED can be achieved by the provision of the first curved surface and the second curved surface and by the difference between the curvatures of the first curved surface and the second curved surface. Moreover, the collimated beam pattern of the light output through the lens can be changed by the variation of the curvatures of the first curved surface and the second curved surface so that said LED can fulfill the requirement of the application in illumination or alarming.

### BACKGROUND OF THE INVENTION

1. Field of the Invention

This invention relates to a collimation structure of LED module and a lamp using said LED module, particularly to a collimation structure of LED module which can collimate the light irradiated from a light emitting source by the design of different curvatures in a first curved surface and a second curved surface of a lens. The collimated light beam pattern of the light output from the lens can be changed when the curvatures of the first curved surface and the second curved surface of the lens are changed. Therefore, the LED module can be applied in lamp used for lighting or alarming.

2. Brief Description of Prior Art

Generally, a car or a motorcycle is provided with a certain quantities of car lamps for lighting or auxiliary showing car driving direction, and enhance side-alarming action of the car body. Nowadays, not only car lamps should have required functions on shaping, lighting and alarming, but also aesthetic on lamp light should not be neglected. Therefore, aesthetics on the car lamps technology has become an important part of car technology. Car lamp taking the lead looks like a pair of beautiful and appealing eye which can further catch public attention. It is this reason why each car lamp maker often provides novel car lamp with contemporary design on the market. People can easily ascertain that some car lamp is used on which maker, which series or possesses any other features besides abovementioned functions.

The above car lamp has a lamp body and a light source, such as LED, provided within the lamp body, a reflection hood being provided around the light source, and a lamp cover being fixed on the front side of the lamp body. The random dispersed light beam in little amount irradiated from the LED onto the reflection hood is reflected and collimated by the reflection hood so as to output through the lamp cover.

However, inasmuch as the light irradiating angle of the light emitting from LED is very narrow, there is little light output from the side part of LED. Thus, little effect is achieved to reflect and collimate the light output from the light source within a certain range by the reflection hood such that the control on the width and height of light irradiation region according to the lighting or alarming demand cannot be assured. Therefore, the application of LED in lamp is seriously restricted.

### SUMMARY OF THE INVENTION

The main object of the present invention is to provide a collimation structure of LED module and a lamp using said LED module in which the collimation structure of LED module can collimate the light emitted from light source, e.g. LED, by the provision of a lens having two curved surfaces in combination with LED and by the difference between the curvatures of the first curved surface and the second curved surface. Moreover, the collimated beam pattern of light output through the lens can be changed by the variation of the curvatures of the first curved surface and the second curved surface so that this LED can fulfill the requirement of application in lighting or alarming.

In order to achieve the above object, this invention provides a collimation structure of LED module which comprises a lens having a first curved surface and a second curved surface, and the curvatures of both are different from each other. The LED module is formed in such a manner that the transverse length of beam patter of the collimated light is controlled by the first curved surface, while the longitudinal width of collimated light is controlled by the second curved surface, a LED light source being provided on the circuit board, the lens being fixed on the circuit board and being located at the light output end of the LED light source.

Preferably, the LED module can be installed within a reflection hood having a reflection surface on the inner surface thereof.

Preferably, the reflection hood is formed by a plurality of reflection segments joined together.

The lamp of the present invention is formed by installing at least one LED module on the lamp socket of the lamp and incorporating a lamp hood to the lamp socket so that the lamp can be applied as an car lamp or the other varieties of lamp.

### BRIEF DESCRIPTION OF THE DRAWINGS

FIG. 1 is a perspective exploded schematic view showing the LED module of the present invention.

FIG. 2 is a front view showing the first embodiment of the LED module of the present invention.

FIG. 3 is a side view showing the first embodiment of the LED module of the present invention.

FIG. 4 is a view showing the beam pattern of the light output of the first embodiment of the LED module of the present invention.

FIG. 5 is a front view showing the second embodiment of the LED module of the present invention.

FIG. 6 is a side view showing the second embodiment of the LED module of the present invention.

FIG. 7 is a view showing the beam pattern of the light output of the second embodiment of the LED module of the present invention.

FIG. 8 is a perspective exploded schematic view showing the LED module and the reflection hood of the present invention.

FIG. 9 is an assembled schematic view showing the LED module and the reflection hood of the present invention.

FIG. 10 is a schematic view showing the state that a plurality of LED modules is assembled in the lamp.

FIG. 11 is a schematic view showing the state that a plurality of LED modules provided with a reflection hood is assembled in the lamp.

FIG. 12 is a schematic view showing the state that a plurality of LED modules provided with another type of reflection hood is assembled in the lamp.

### DETAILED DESCRIPTION OF THE PREFERRED EMBODIMENTS

The objects, the technical contents and the expected effectiveness of the present invention will become more apparent from the detailed description of the preferred embodiment in conjunction with the accompanying drawings.

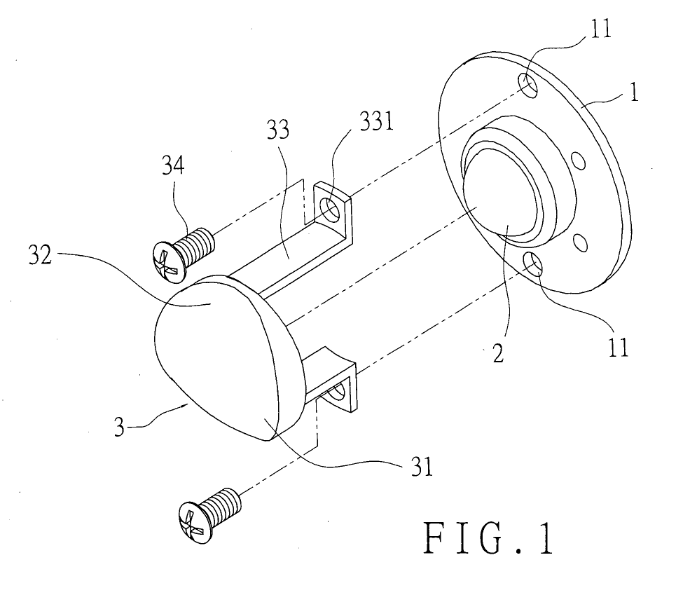

FIG. 1 is a schematic view showing a preferring embodiment of the collimation structure of the LED module of the present invention. The collimation structure of the LED module of the present invention comprises a circuit board (1), a LED light source (2) and a lens (3).

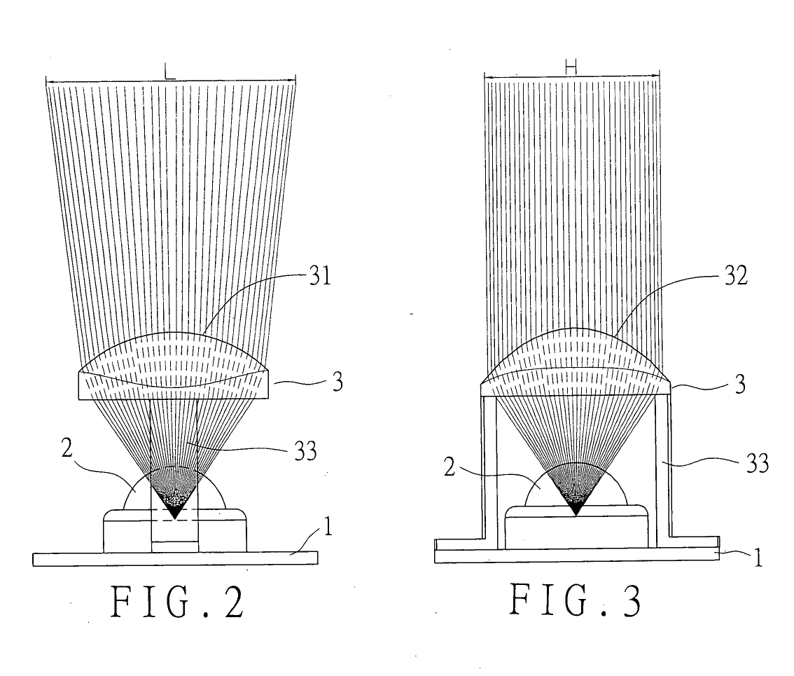

Referring to FIGS. 2 to 4, the LED light source (2) is provided on the circuit board (1), and a pair of through holes (11) are provided on both sides of the circuit board (1). The lens (3) is a double curved surfaces structure having a first curved surface (31) and a second curved surface (32), both have different curvatures. The transverse length (L) of beam patter of the collimated light is controlled by the first curved surface (31) and the longitudinal width (H) of the collimated light is controlled by the second curved surface (32). A pair of supports (33) integral with the lens (3) are provided at two sides of the lens (3) respectively, and two holes (331) corresponding to the holes (11) provided at two sides of the circuit board (1) are provided on the pair of supports (33) so as to fix the lens (3) on the circuit board (1) by a pair of fixing bolts (34) passing through the pair of holes (11) and the pair of holes (331). Furthermore, the lens (3) is located at the light output end of the LED light source (2). In this manner, the LED module is formed accordingly.

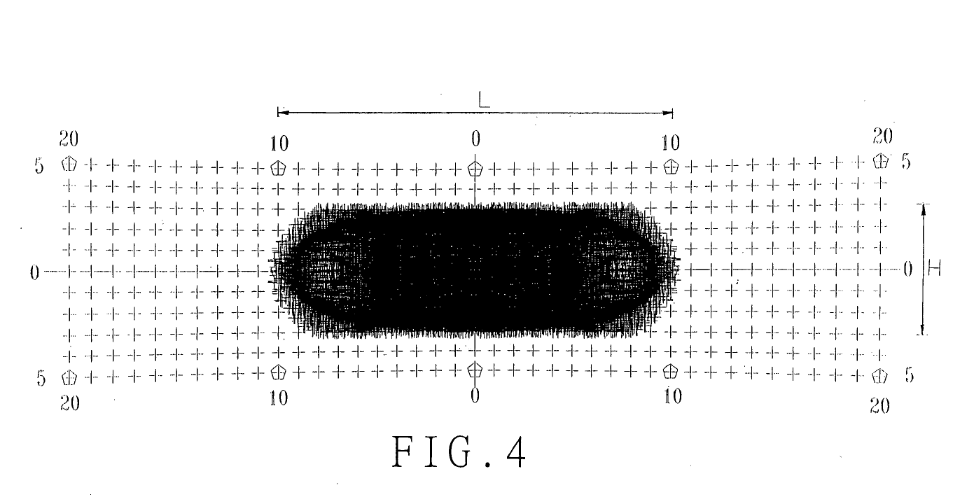

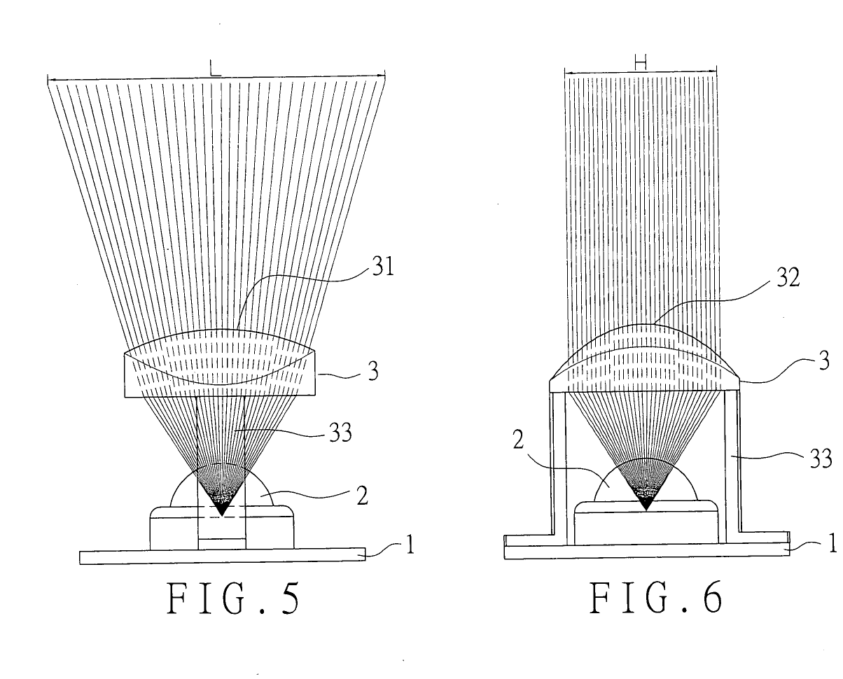

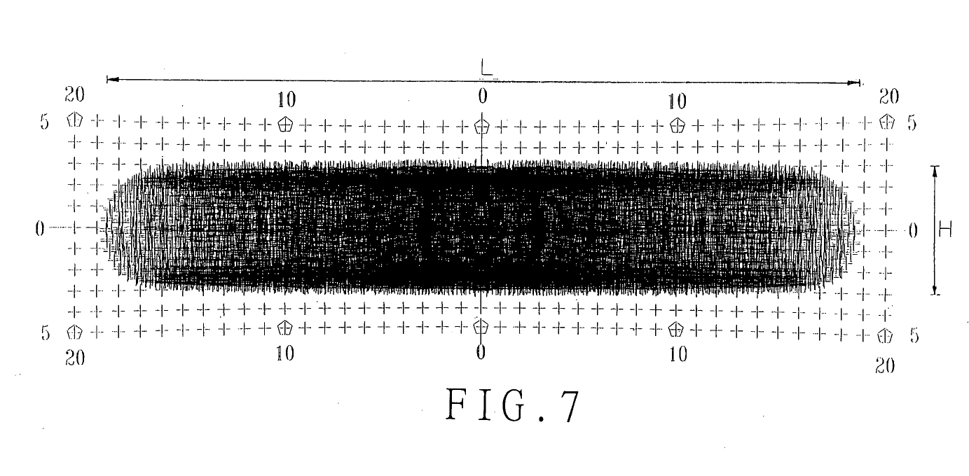

In FIGS. 2 and 3, two schematic views showing the path of light output passing through the lens (3) from the LED light source (2) of the LED module are present. From both figures showing the path of light output, it is found that the covering ranges of the light output in the transverse and longitudinal directions have apparent differences. FIG. 4 shows the beam pattern of the light output. In FIGS. 5 and 6, when the curvature of the second curved surface (32) of the lens (3) is changed, it is found that the covering range in the transverse direction of the light output passing through the lens (3) from the LED light source (2) of the LED module is apparently different from that shown in FIG. 2. FIG. 7 shows the beam pattern of light output.

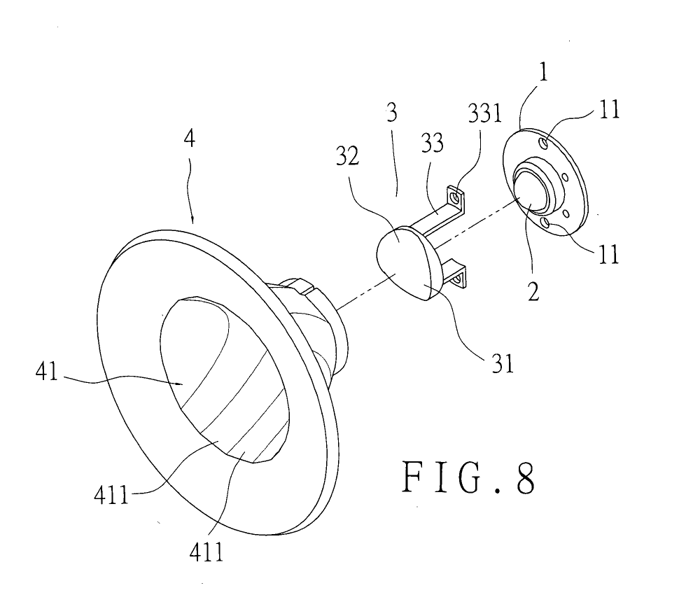

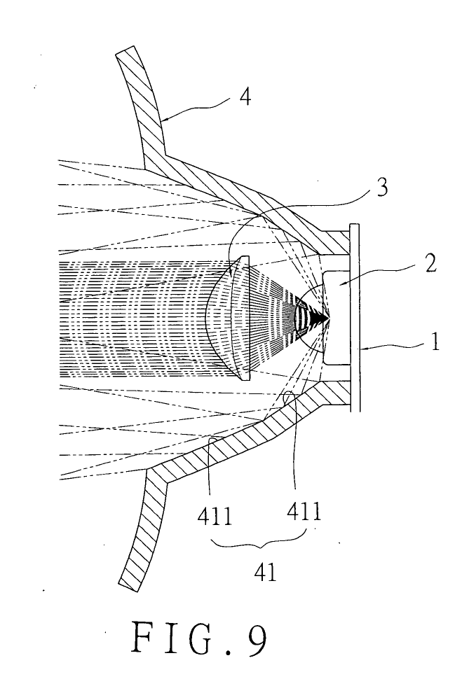

As shown in FIGS. 8 and 9, the LED module of the present invention can be further provided within a reflection hood (4) having a reflection surface (41) provided on the inner surface thereof. Moreover, the reflection surface (41) is formed by a plurality of reflection segments (411) joined together.

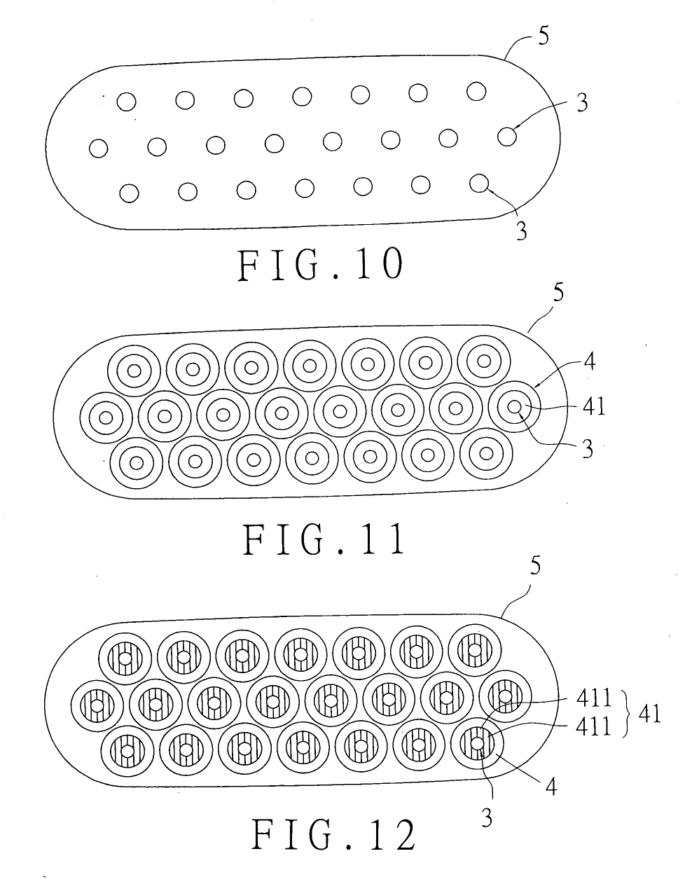

In FIGS. 10 to 12, schematic views showing application of the LED module of the present invention in lamp (5) are present. At least one LED module is assembled in the lamp (5) which is used as the car lamp for lighting or alarming of automobile, or as the other lamp for lighting, alarming, and decoration. FIG. 10 shows the state that a plurality of LED modules are assembled in the lamp (5), FIG. 11 shows the state that a plurality of LED modules provided with a reflection hood (4) are assembled in the lamp (5), and FIG. 12 shows the state that a plurality of LED modules provided with a reflection hood (4) formed by a plurality of reflection segments (411) joined together are assembled in the lamp (5).

The abovementioned are merely preferred embodiments of the present invention, and should not be considered as a limitation on the structural aspect and dimension of the present invention. Equivalent variations and modifications made by the pivot-joint skilled in the art without departing from the spirit and scope of the present invention are still considered to be within the scope of claim of the present invention.

Summing up above, the embodiment of the collimation structure of LED module of this invention can reach expected effectiveness, and the specific configurations disclosed herein have yet not seen in the prior art of the same category of product, even has not been opened to the public before application.

What is claimed is:

1. A collimation structure of LED module, wherein the collimation structure of LED module comprises a lens which is a double curved surface structure having a first curved surface and a second curved surface, and the curvatures of both are different from each other, the transverse length of beam patter of the collimated light being controlled by the first curved surface, while the longitudinal width of collimated light being controlled by the second curved surface, a LED light source being provided on the circuit board, the lens being fixed on the circuit board and being located at the light output end of the LED light source.

2. A collimation structure of LED module as claimed in claim 1, wherein the LED module is installed within a reflection hood having a reflection surface on the inner surface thereof.

3. A collimation structure of LED module as claimed in claim 2, wherein said reflection hood is formed by a plurality of reflection segments joined together.

4. A lamp, wherein the lamp is provided with at least one LED module, the LED module comprises a lens which is a double curved surface structure having a first curved surface and a second curved surface, and the curvatures of both being different from each other, the transverse length of beam patter of the collimated light being controlled by the first curved surface, while the longitudinal width of collimated light being controlled by the second curved surface, a LED light source being provided on the circuit board, the lens being fixed on the circuit board and being located at the light output end of the LED light source.

5. A lamp as claimed in claim 4, wherein said LED module is installed within a reflection hood having a reflection surface on the inner surface thereof.

6. A lamp as claimed in claim 5, wherein said reflection hood is formed by a plurality of reflection segments joined together.
